(19) United States
(12) Patent Application Publication
(10) Pub. No.: US 2024/0219891 A1
(43) Pub. Date: Jul. 4, 2024

(54) METHOD, APPARATUS AND SYSTEM FOR ADAPTING A PRODUCTION PROCESS

(71) Applicant: Siemens Aktiengesellschaft, München (DE)

(72) Inventors: Raven Thomas Reisch, München (DE); Carsten Schuh, Baldham (DE); Friedrich Lupp, Gauting (DE)

(21) Appl. No.: 18/554,964

(22) PCT Filed: Mar. 21, 2022
(86) PCT No.: PCT/EP2022/057343

§ 371 Date: Oct. 11, 2023

(30) Foreign Application Priority Data
Apr. 13, 2021 (EP) 21168125.9

(51) Int. Cl. G05B 19/4155

(52) U.S. Cl. CPC G05B 19/4155; G05B 2219/32301

(57) ABSTRACT

A method for modifying a production process for a product wherein the production process can be qualified by means of at least one quality parameter for the product and includes a plurality of individual processes, in at least some of which no control is used. The method includes the following steps: a) capturing at least one measurement quantity of at least one individual process without control; b) determining a quality parameter corresponding to the at least one measurement quantity; c) comparing the determined quality parameter with a desired value, which results from the measurement-quantity-associated individual process with control; d) evaluating, on the basis of the comparison, whether the use of control for the at least one individual process leads to an improvement in the quality parameter.

### CROSS-REFERENCE TO RELATED APPLICATIONS

This application claims priority to PCT Application No. PCT/EP2022/057343, having a filing date of Mar. 21, 2022, which claims priority to EP Application No. 21168125.9, having a filing date of Apr. 13, 2021, the entire contents both of which are hereby incorporated by reference.

### FIELD OF TECHNOLOGY

The following relates to a method for adapting a production process, a corresponding apparatus, a system having this apparatus, a computer program product, and a computer-readable storage medium.

### BACKGROUND

The aims of industrial manufacturing include fulfilling customer demands or meeting certain specifications. These specifications are frequently referred to as “critical to quality” parameters or CTQs.

Characteristics to be defined, which have an influence on the quality of the end product, intermediate product, a component, or a manufacturing step for a component, are used to determine whether these specifications are satisfied.

AHMED ALTAF ET AL: “Reliability and Quality Control Approach for Collaborative Assembly Process” (published in 2019 16TH INTERNATIONAL BHURBAN CONFERENCE ON APPLIED SCIENCES AND TECHNOLOGY (IBCAST), IEEE, Jan. 8, 2019 (2019 Jan. 8), pages 210-217) discloses an approach for controlling reliability and quality in the context of machine/human collaboration. Human and machine parameters are considered for this control.

Document US2003/0204378 A1 discloses a monitoring unit or “controller” and a monitoring method for a mass product production process, in particular from the field of semiconductor manufacturing, within the scope of which an improvement for the process monitoring is proposed.

To fulfill the specifications, or else optimize a process, use is often made of control loops or closed-loop controls for a process or process step, by means of which an initial value, for example a certain temperature, is maintained to the best possible extent even if an interfering influence, for example a change in ambient temperature, is present. To this end, a target value, for example the desired temperature, is compared with an actual value, for example the actually measured temperature, at defined time intervals within the control loop. A manipulated variable, which influences the process or the process step such that the deviation adopts a minimum after a certain “adjustment time” or in the settled state, is a determined from the deviation or control difference.

The control loop comprises individual control loop members such as a loop controller and a controlled system, which each have a dynamic response. This may render it difficult to implement a correct setting, but incorrectly set loop controllers lead to the control loop not operating appropriately, for example not being sufficiently quick, leading to a large system deviation, or leading to undamped fluctuations in the controlled variable, which may destroy components of the control loop, or at least not lead to an improvement of the manufacturing process or step. Thus, the decision as to whether a control loop is used must be taken carefully on the basis of the information available.

### SUMMARY

Using this as a starting point, an aspect relates to propose an improvement of manufacturing or production processes.

A product is manufactured by means of a production process comprising at least one individual or component process where no closed-loop control is used. The product can be an intermediate product or an end product.

The product is qualifiable by at least one quality parameter, for example a certain “window” which is defined by one or more quality parameters or CTQs. By way of example, the dimension of the “window”, which is to say whether this is a path, a rectangle, or a cuboid or higher-dimensional figure, is defined by the number of CTQs. Thus, a quality parameter can be formed from one or more individual quality parameters or CTQs.

For at least one individual process without closed-loop control, a measured variable is captured from this individual process. Thus, this may for example also relate to a group of individual processes.

A measured variable can be a simple measurement value from a sensor such as a temperature or a deposition rate. As an alternative or in addition, a measured variable may comprise a temporal or spectral curve or contain values derived from one or more sensor data.

The measured variable may relate to an individual process or a group of individual processes.

A quality value or quality parameter corresponding to this measured variable is determined from the real production process, which is to say when no closed-loop control is envisaged for the individual process.

This quality parameter is compared with a target value that arises when the individual process from which the measured variable originates is carried out with closed-loop control.

According to an advantageous embodiment, this target value is determined by means of a simulation in which the individual process or the group of individual processes is simulated under the assumption of the presence of closed-loop control.

Whether the use of closed-loop control for the individual process leads to an improvement in the quality parameter is derived from this comparison.

According to an advantageous embodiment, this result is implemented in the production process, which is to say closed-loop control is introduced in the case of a sufficient improvement or the production process is maintained if there is no improvement or no sufficient improvement. Whether an improvement is sufficient is determined, for example, on the basis of a cost-benefit analysis, in which the costs for closed-loop control are compared with the expected savings and improvements in the product.

According to a first advantageous embodiment, the quality parameter is determined from an analysis of the product; for example, one or more CTQs are determined for the end product or else an intermediate product. The target value is determined from a simulation of at least one individual process in which closed-loop control is implemented and the measured variable or measured variables are used as parameters. As an alternative or in addition, the simulation, in particular a joint simulation, is implemented for a group of individual processes. Thus, a simulated quality parameter can be derived for the individual process or—if the simulation also comprises further individual processes—for groups of individual processes or the overall process. This simulated quality parameter is then used as a target value and hence it is possible to determine whether the real quality parameter from a production process without closed-loop control or the simulated quality parameter from a fictitious production process with closed-loop control is more advantageous, and accordingly whether or not closed-loop control should be advantageously implemented.

Particular advantages of this embodiment are that the simulation product runs parallel in time and also in intermeshed fashion with the real production. Thus, an analysis also based on current data of the production process can be carried out during the production process. This allows a decision as to whether closed-loop control is introduced into the production process to be made without a loss of time and without costs arising for the implementation or without costs arising for a complicated modeling and simulation of the entire production process, as would be the case for instance in the case of what is known as a “digital twin”.

According to a further advantageous embodiment, a quality parameter which allows the individual process or partial process to be assigned to available data, for example a database containing empirical values of earlier implementations, is derived from the measured variables. These available data contain a target value which specifies whether or not closed-loop control is advantageous for the partial process, which is to say leads to an improvement in the quality parameter, with the result that a corresponding decision can be made about the implementation of closed-loop control.

### BRIEF DESCRIPTION

Some of the embodiments will be described in detail, with reference to the following figures, wherein like designations denote like members, wherein:

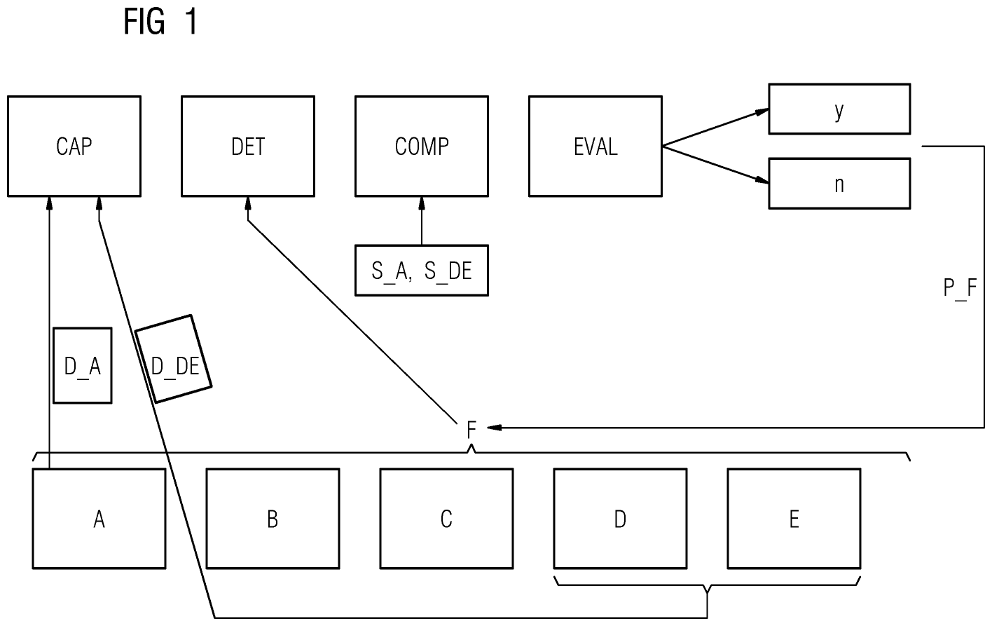

FIG. 1 shows an exemplary embodiment of the method for adapting a production process;

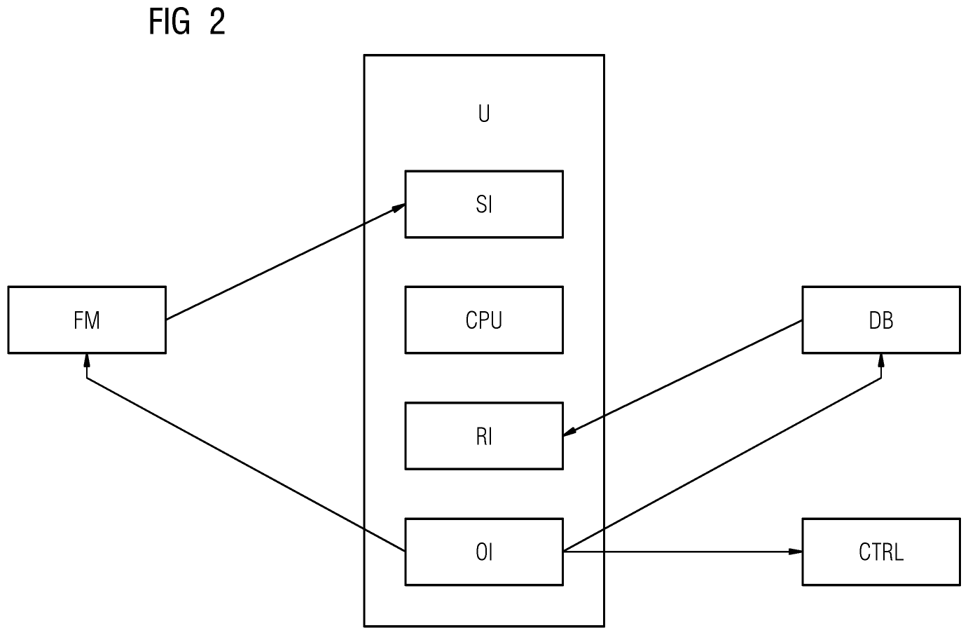

FIG. 2 shows an exemplary embodiment of an apparatus for carrying out the method for adapting a production process;

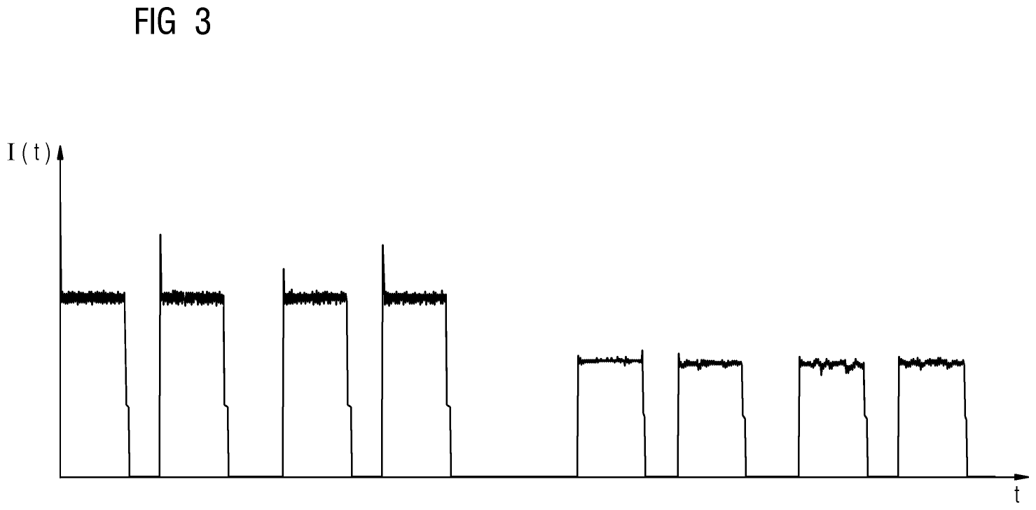

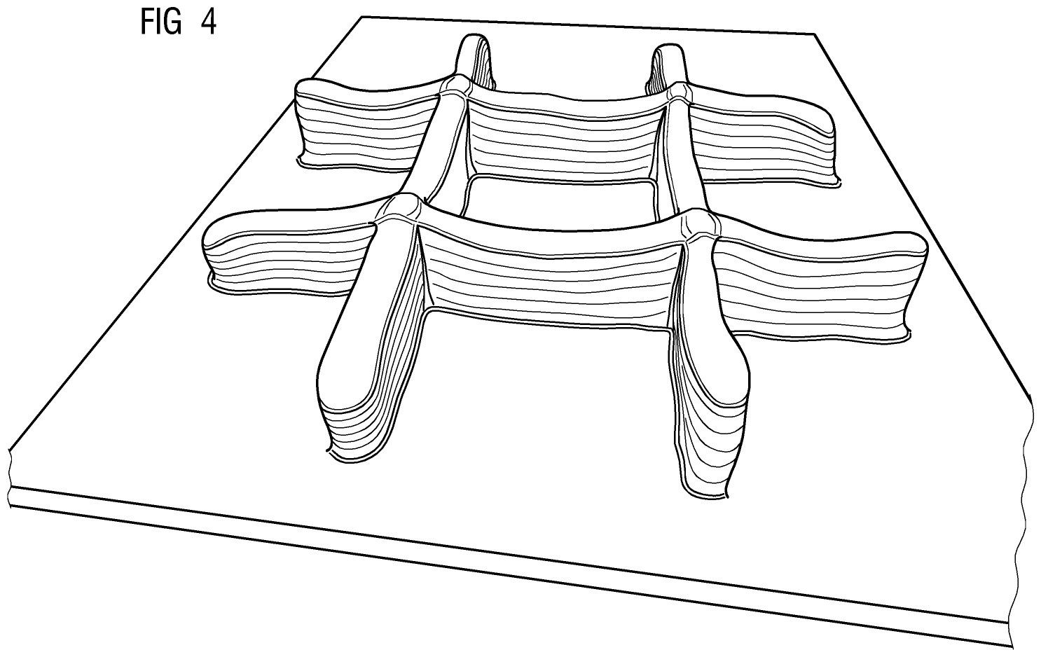

FIG. 3 shows a curve of current over time for the workpiece of FIG. 4;

FIG. 4 shows a product produced by means of wire arc additive manufacturing (WAAM); and

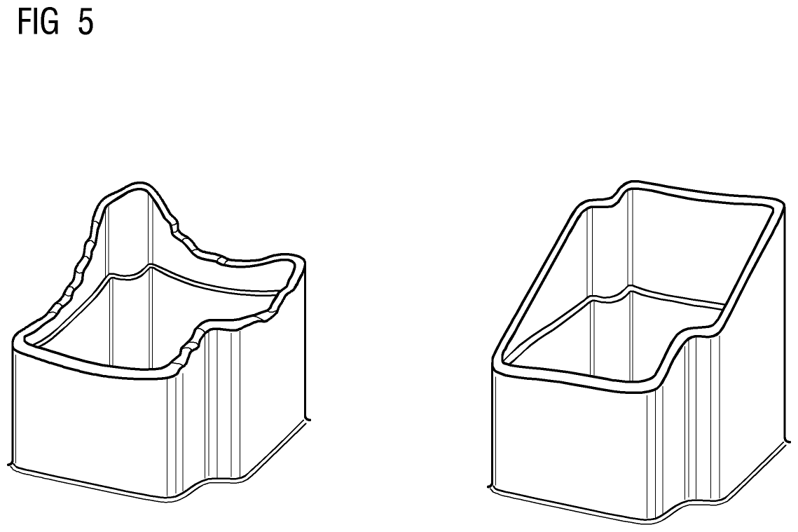

FIG. 5 shows an edge element created by means of laser metal deposition (LMD) without closed-loop control (left-hand side) and with closed-loop control (right-hand side).

### DETAILED DESCRIPTION

FIG. 1 illustrates an exemplary manufacturing process F, which encompasses a multiplicity of individual processes. Individual processes A to E are depicted in FIG. 1.

The decomposition of the entire manufacturing process into individual processes is implemented while taking account of which individual processes or process clusters are critical for a desired property, for example a customer specification or any other requirement in relation to the production, for example given an upper limit of rejects. As an alternative or in addition, groups of individual processes that are relevant for a desired property, which for example is influenced by the properties of the individual processes, are taken into account.

For the example of a component produced by means of WAAM (wire arc additive manufacturing), it is possible to divide the entire manufacturing process into material deposition for creating the blank, thermal treatment for influencing the material structure, and post-processing, for example by milling with suitable tools, especially micro-tools.

As an alternative or in addition, the decomposition is such that a check is carried out as to whether the respective individual process or group of individual processes is suitable for constructing a controlled system.

As an example of this, FIG. 4 shows a workpiece produced by means of WAAM, and the corresponding current curve for the welding head is shown in FIG. 3. Firstly, it is possible to identify that the current profile has rectangles, with each rectangle corresponding to a strand of the workpiece shown in FIG. 4 since material can only be deposited in the case of current flow. Furthermore, it is possible to identify spikes at the start of each rectangular current curve, since this is where the arc first forms. In the second series of rectangles on the right-hand side, it is possible to identify regions with a reduced current, which correspond to the intersections of perpendicular and horizontal strands. At the intersections, the distance of the workpiece from the blowtorch, resulting in what is known as the “stick out”, i.e. the length of the protruding wire, is less; thus, less current is required. Closed-loop control is advantageous here on account of the low speed; a distance of the blowtorch from the workpiece can be used as controlled variable.

The controlled system refers to that part of a control loop or closed-loop control which contains the variable to be controlled, which is to say the controlled variable, on which the loop controller is intended to act via the manipulated variable.

Possible advantages of closed-loop control are evident in FIG. 5 on the basis of a product produced by means of laser metal deposition (LMD). The edge element on the left-hand side, created by means of laser metal deposition (LMD) without closed-loop control, has excess height at the corners and reduced material deposition in the region of the center of the edges. A material deposition corresponding to the desired profile could be obtained in the workpiece on the right-hand side by means of closed-loop control.

In a production process, the ambient temperature of the production installation, for example, can be used as controlled variable. Further, a fill level of a container with material used during a deposition, welding or casting method or for instance the position of a laser used for a laser deposition method can be used as controlled variables.

For the example of the WAAM process, for the purpose of the material deposition, closed-loop control can be implemented for the distance of the blowtorch from the blank to be coated, whereby it is possible to define an application rate or else possible to prevent the blowtorch and blank to be processed from colliding, as likewise already explained. For the thermal treatment, it is possible to subject the temperature of the blank, which is relevant to the structure formation, to closed-loop control. Mathematically, closed-loop control can be described by means of a transfer function.

From the overall number of individual processes and/or process clusters or groups, individual processes or groups of processes suitable for closed-loop control are selected. In FIG. 1, this selection consists of the individual process A and a group consisting of the individual processes D and E, for which no closed-loop control is provided within the scope of the manufacturing process F.

Data D_A, D_DE which are able to influence the quality of a finished or intermediate product, which is to say “CTQ” relevant data, are captured for this selection of individual processes. For example, an established drilling process, which is to say a drilling process that has proven its worth, need not be CTQ relevant because it can be performed in such a way that it can be reliably performed without loss of quality on the part of the product.

Thus, the data D_A of the individual process A or/and the data D_DE of the group of processes D, E, captured in the step CAP, are defined, for example queried by a control unit or transmitted to the latter, so that it is possible to use said data to determine a simulated quality parameter, a closed-loop control method being used for this simulation. The data D_A and D_DE are one or more measured variables from the individual process A and the group of individual processes D, E, respectively, or variables derived from the measured variables or measurement values.

A quality value or quality parameter corresponding to this measured variable or these measured variables is determined in the step DET on the basis of these data D_A, D_DE. This quality value is often referred to as a CTQ. A CTQ is determined for the individual process A or for the group of individual processes D, E. Alternatively or in addition, a CTQ can be determined for a combination of individual processes or/and groups of individual processes. For example, a first CTQ, which describes the admissible oxygen content, can be used together with a second CTQ, for example a utilized vapor deposition material with corresponding purity, to determine a combined CTQ, for example a specific structure of the applied material or a specific purity of the applied material.

In the step COMP, this determined quality value is compared with quality values that were simulated for the respective processes. This simulation is implemented under the assumption of closed-loop control for the respective individual process. FIG. 1 shows the simulated quality parameter S_A for the individual process A and the simulated quality parameter S_DE for the group D and E of individual processes.

The comparison COMP between the quality parameters S_A, S_DE simulated under the assumption of closed-loop control and the actual process parameter available from the manufacturing process F, where no closed-loop control was present in the relevant individual process, can then be used in an evaluation step EVAL to establish whether or not closed-loop control is advantageous. Thus, a proposition P_F as to whether or not the introduction of a loop controller offers advantages is created for the manufacturing process F.

The left of FIG. 5 shows a workpiece in which material was deposited by means of a laser metal deposition (LMD) process without closed-loop control. It is possible to identify clear excess height at the corners. The desired uniform slope is achieved more reliably on the right-hand side by way of closed-loop control; thus, closed-loop control is advantageous if the profile represents a CTQ, which is to say a deviation therefrom would lead to the workpiece having to be rejected.

The data D_A, D_DE can in particular be sensor values recorded in conjunction with the individual process. These can be numerical data such as the deposition rate, temperature of the target to be coated, pressure in the evaporation tank, in the case of a deposition process. As an alternative or in addition, this may also relate to more complex information such as a spectrum with the quantitative component of contaminants, for example carbon.

For the WAAM example, the spectrometer data can be used to determine whether there is an elevated O₂ component, thus possibly leading to a necessary increase in the protective gas supply.

As an alternative or in addition, the data comprise parameters that find use in the relevant individual process A or group of processes D, E. For example, this could be the current intensity used to operate the electron-beam gun for the vapor deposition process. As an alternative or in addition, these could be a current profile over time for the operation of the electron-beam gun.

Now, there is a real operation of the process chain encompassing individual processes A to E. Relevant data or/and parameters from at least one of these individual processes or/and at least one group of individual processes are transmitted to an “edge device”, which is to say said relevant data and/or parameters are queried by or transmitted to the latter.

An edge device is a network component which enables an access to data on a network. In the example of the manufacturing process, this thus relates to a component which is able by means of a network, at least in part, to access data in the manufacturing process, the individual steps thereof, or the components used to that end.

In particular, the edge devices can be routers, which is to say components able to transmit data packets from one network to at least one other network, gateways, which is to say components for communicating between 2 systems, or servers, which is to say components providing resources for other components. As an alternative or in addition, the edge device can be a virtual device or virtual machine, which is to say a computer system which is generated on another computer system and encapsulated by the original system. This virtual machine can be realized in a cloud, which is to say IT infrastructure made available via a network, for example the Internet, or on a computer, for example a PC in the network or with access to the network in which the machines used in the manufacturing process are also located.

In the example shown in FIG. 1, data D_A from the individual process and data D_DE of the group D, E of processes are captured by means of the device U shown in FIG. 2. By way of example, the device U can be a controller for production installations, for example a SIMATIC S7-1500, or the device U is advantageously realized in a virtual device or/and can communicate with the latter via a communications interface. This is advantageous in that manufacturing machines can be operated at a manufacturer. The latter is in contact via a communications link with infrastructure on which the edge device is realized, the latter in turn having access to services of a database DB or cloud C, with the aid of which transfer functions can be determined or simulations can be carried out.

A simulation of closed-loop control of the selected processes A and D, E or a part thereof using at least some of the transmitted data or/and parameters is implemented on the edge device, which is connected to the device U shown in FIG. 2. By way of example, the closed-loop control is based on an already available transfer function for an existing, similar process or partial process. A transfer function for the closed-loop control is understood to mean the mathematical relationship between input signal for the process/partial process and the output signal. Transfer functions are already available for a multiplicity of closed-loop control processes, and these are then adapted to the individual closed-loop control process. Conventional modeling programs such as MATLAB offer options or tools for carrying out a fine adjustment of the parameters in the control loop. As an alternative or in addition, this fine adjustment can be obtained for example by machine learning methods such as so-called deep learning or on the model level by meta learning or transfer learning.

The simulation of closed-loop control for at least one selected partial process is implemented parallel in time with the ongoing manufacturing process, without intervening in the latter. The simulation also contains the effect the closed-loop control has on the preceding or subsequent individual processes, which is to say on the operational behavior of the process chain overall.

Now, the process data or process parameters actually generated by the ongoing manufacturing process are compared, during that process, with the data or parameters from the simulation. The quality parameters or CTQs are particularly suitable for this comparison since this allows direct conclusions to be drawn as to whether the process is better suited to the manufacturing with closed-loop control—i.e., by the data generated by the simulation—or without closed-loop control—as in the real manufacturing process.

For example, in the example of the vapor deposition process, there is a comparison between the times required to obtain the envisaged layer thickness and the qualities of the layers created. By way of example, the quality can be determined by a subsequent x-ray structure analysis, for example with regard to whether the layer structure is epitaxial or/and which foreign bodies were introduced, for example from the crucible for the vapor deposition material.

Hence, it is possible to determine whether individual parameters or groups of parameters are more likely to attain the required result with or without the use of the relevant closed-loop control process or processes. This allows the identification of weak spots, which is to say which individual processes are very sensitive vis-à-vis bothersome interferences arising and therefore require closed-loop control or would bring about a loop controller deflection or a manipulated variable unequal to zero. Furthermore, there can be quantitative examinations to the effect of whether the use of closed-loop control would bring about improvements in the considered manufacturing process.

In particular, the finished product can also be used to determine which component of the production result would be located outside of the admissible window for quality parameters. As described, this window is described by way of so-called CTQs or “critical to quality” features or quality-critical features. Thus, it is possible to capture, e.g., measure, these CTQs, and these must be satisfied to meet customer specifications, for example. Using the CTQs, it is possible to define certain regions or windows in which this is the case. Quality parameters can be formed from one or more CTQs.

Hence, it is also possible to determine a reject rate of a finished or partial product in the process without using the relevant loop controller or controllers, and this can be compared with the rejection rate that would have occurred in the case of a process with a loop controller, and also the costs connected therewith.

As an alternative or in addition, it is possible to compare the required machine times or material costs, taking account of the additional costs for the control loop or loops.

A concept of implementing one or more closed-loop control processes in the manufacturing process is created and, optionally, one or more closed-loop control processes are actually implemented on the basis of this comparison.

FIG. 2 illustrates a system having an apparatus U for performing the production method. By way of example, the apparatus is an edge device.

At least one individual process from the entire production process is performed on at least one manufacturing machine FM. This manufacturing machine FM contains at least one sensor and interchanges measured variables D_A, D_DE from the corresponding individual process or from the group of corresponding individual processes or corresponding data derived therefrom with the apparatus U. A sensor interface SI is provided in the apparatus U for capturing purposes. In a processor unit CPU, the actual quality values determined from the measured variables are compared with quality values or target values simulated under the assumption of closed-loop control. This target value can be received by way of a receiver interface RI or can alternatively be calculated by the apparatus U itself, for example in the processor unit CPU. In this context, the target value and further information can be interchanged with an internal or external data memory DB, for example a database of a production process vendor, possibly stored in a cloud. In particular, the further information also contains a transfer function for closed-loop control. Then, a corresponding proposition regarding the change or maintenance of the production process can be output via an output interface OI and optionally be output, in particular together with an implementation of the closed-loop control, to the manufacturing machine FM or a central production controller, for example a tool CTRL for creating or optimizing production processes, or else to the external data memory DB for further processing purposes. The tool CTRL can also be a software as a SAAS (software as a service), which runs at the customer or at the software vendor.

According to another embodiment, not depicted here, CAD/CAM software or closed-loop control for technology such as for example milling, turning, WAAM (wire arc additive manufacturing), LMD (laser metal deposition) is offered for a producer/vendor of a CAD (computer-aided design) component and associated CAM (computer-aided manufacturing) operations.

There is a component and operation analysis of new components with regard to critical regions, for example T-joints, which is to say the connection of the two welded parts in a T-shape, fill structures, etc. The measured variables to be captured arise therefrom.

The measured variables, for example once again the measured variables D_A or D_DE, are used to derive a quality value, for example an identification of the relevant individual process A on the basis of the process type, for example “material deposition”, and the employed components, for example “type X blowtorch” or “type Y electron-beam gun”.

This enables an assignment to available data in a database containing empirical values from earlier implementations. Thus, according to this embodiment, the specified values S_A for the individual process A or/and specified values S_DE for the group D, E of individual processes are taken from a database which contains information regarding processes or/and component properties with great need for closed-loop control. Such processes or components lead to what are known as “out of CTQs” or to rejects with above-average frequency. The data in the database are based on empirical values, for example by actually implemented loop controllers for the corresponding technology, component or process.

For example, these data comprise a target value S_A which specifies whether or not closed-loop control is advantageous for the partial process, which is to say leads to an improvement in the quality parameter.

Even though embodiments of the invention was described in conjunction with specific preferred exemplary embodiments, in particular in relation to WAAM or other deposition methods, it is evident to a person skilled in the art that combinations or modifications thereof, be it in full or in terms of individual aspects, are possible for all exemplary embodiments. In particular, an application to other production processes, for example chemical or mechanical methods, is also envisaged. In this case, corresponding quality parameters could be, for example, the purity of a substance, reaction parameters, mechanical conditions such as load-bearing capacity, etc.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for adapting a production process for a product, the production process being qualifiable by means of at least one quality parameter for the product and comprising a plurality of individual processes,
wherein closed-loop control is not used at least intermittently during the plurality of individual processes the method comprising:
a) capturing at least one measured variable of at least one individual process without closed-loop control using a control loop;
b) determining at least one quality parameter corresponding to the at least one measured variable;
c) comparing the determined quality parameter with a target value which arises from the at least one individual process belonging to the measured variable, with closed-loop control using a control loop; and
d) evaluating, by way of the comparing, whether the use of closed-loop control using a control loop leads to an improvement in the quality parameter for the at least one individual process.

2. The method as claimed in claim 1, wherein the target value is determined in step c) by:
i) simulating the individual process or/and a group of processes using closed-loop control, with the measured variable being used as a parameter in a simulation;
ii) calculating a simulated quality parameter by means of the simulation;
iii) using the simulated quality parameter as target value.

3. The method as claimed in claim 1, wherein the quality parameter corresponding to the measured variable is determined on a basis of the actually created product.

4. The method as claimed in claim 1, wherein the determining according to step b), the comparing according to step c), and the evaluating according to step d) are implemented parallel in time with the real production process.

5. The method as claimed in claim 2, wherein the simulation includes consideration of at least one further individual process which differs from the individual process from which the measured variable originates.

6. The method as claimed in claim 2, wherein the simulation includes consideration of an entire portion of the production process which influences the quality parameter.

7. The method as claimed in claim 1, further comprising:
e) creating a modification proposition on a basis of the evaluation containing the use of a control loop:
f) adapting the real individual process and/or the group of processes according to the modification proposition.

8. The method as claimed in claim 1, wherein the measured variable is transmitted to a comparison unit, and the determining according to step b), the comparing of the determined quality parameter in step c), and the evaluating according to step d) are carried out in the comparison unit.

9. The method as claimed in claim 1, wherein the measured variable contains sensor data from at least one sensor.

10. The method as claimed in claim 1, wherein the measured variable comprises a temporal and/or spectral curve of sensor data from at least one sensor and/or values derived from the sensor data from the at least one sensor.

11. An apparatus for carrying out the method as claimed in claim 1, comprising
a) a sensor interface for capturing measured variables:
b) a processor unit for comparing a determined quality parameter for at least one individual process with a target value;
c) a receiver interface for receiving target values, and
d) an output interface for outputting a modification proposition.

12. The apparatus as claimed in claim 11, realized as an edge device.

13. A computer program product, comprising a computer readable hardware storage device having computer readable program code stored therein, said program code executable by a processor of a computer system to implement a method as claimed in claim 1.

14. A computer-readable storage medium having the computer program product as claimed in claim 13.

15. A system comprising the apparatus as claimed in claim 11, a machine for carrying out at least one individual process in the production process for a product, wherein the machine interchanges measured variables of the at least one individual process with the apparatus and the apparatus furthermore interchanges information in relation to a target value, with a data memory.
